(19) United States
(12) Patent Application Publication
(10) Pub. No.: US 2025/0103785 A1
(43) Pub. Date: Mar. 27, 2025

(54) Chip packaging power distribution network electromagnetic modeling method and system

(71) Applicant: XPEEDIC CO., LTD., SHANGHAI (CN)

(72) Inventors: Wenliang DAI, SHANGHAI (CN); Feng LING, SHANGHAI (CN); Zhangmin ZHONG, SHANGHAI (CN); Liguo JIANG, SHANGHAI (CN)

(21) Appl. No.: 18/564,475

(22) PCT Filed: Apr. 11, 2023
(86) PCT No.: PCT/CN2023/087432

§ 371 Date: Nov. 27, 2023

(30) Foreign Application Priority Data
Oct. 21, 2022 (CN) 202211290070.6

(51) Int. Cl. G06F 30/3308; G06F 30/337; G06F 113/18

(52) U.S. Cl. CPC G06F 30/3308; G06F 30/337; G06F 2113/18

(57) ABSTRACT

The present invention discloses a chip packaging power distribution network electromagnetic modeling method and system, belongs to the technical field of chip packaging. Targeting at the problem that for electromagnetic field modeling methods of large-scale power distribution networks currently available, it is not possible to promise both accuracy and speed, the present invention provides a chip packaging power distribution network electromagnetic modeling method, comprising: decomposing an initial power distribution network, and obtaining at least one decomposed region; conducting electromagnetic field solving for each of the at least one decomposed region, and obtaining at least one sub-magnetic field model; conducting circuit connection for each of the at least one sub-magnetic field model, and conducting circuit connection for neighboring sub-magnetic field models, and forming a complete circuit connection; and solving the complete circuit connection, and generating a complete electromagnetic field model.

### TECHNICAL FIELD

The present invention belongs to the technical field of chip packaging, specifically, a chip packaging power distribution network electromagnetic modeling method and system.

### BACKGROUND TECHNOLOGY

With the continuous development of artificial intelligence, 5G and data centers, mass data are generated continually; CPUs of traditional infrastructures can no longer satisfy requirements of high performance computing (HPC). Advanced packaging technology represented by Heterogeneous Integration is an advanced technology in Post-Moore Era, and provides the possibility for realizing a higher computing ability, in the fields of FPGA, GPU, CPU, the heterogeneous integration technology is widely used, and typical examples include Fiji GPU by AMD, and Pascal GPU by Nvidia, wherein a GPU die is connected with surrounding four HBMs via a Si interposer. TSMC, Intel and Samsung are investing persistently in the advanced packaging field. 2.5D and 3D IC advanced packaging is to replace interconnection between chips via packaging substrates with interconnection via silicon substrates or chip stacking by through silicon via (TSV). The most significant advantage of 2.5D and 3D IC is heterogeneous integration, by involving heterogeneous hybrid fabrication can be realized with different process nodes. 2.5D and 3D IC can allocate two dies very close and connecting directly, routing density on the silicon interposer can be much higher than on traditional package, the size of the chip can be smaller, while higher signal performance can be obtained. This poses a new challenge to the electromagnetic field modeling, especially electromagnetic field modeling for power distribution networks. The electromagnetic modeling of power distribution networks is different from electromagnetic field modeling of signals, to this end, areas only containing signal networks among bulks of original data can be picked out according to signal traces, and by including appropriately more areas and conducting electromagnetic field modeling, the accuracy required for signal electromagnetic field model in a certain frequency range can be satisfied. For power distribution networks, during advanced packaging, the power distribution network is usually built by grid-shaped power routing, including via connections between multiple layers of routings. As the power distribution network routing covers basically a large range, it is difficult to pick out a small section for analysis as per trace routings just like what we do for the signal network, thus the electromagnetic field modeling of power distribution networks remains a difficulty in the field of advanced packaging. The current electromagnetic field modeling solution for the advanced packaging power distribution networks is to calculate equivalently with RLCK (resistance, inductance, capacitance and mutual inductance) circuits, the advantage of the algorithms is that a big bulk of data can be processed, however, the accuracy at high frequencies cannot be promised. If the electromagnetic field algorithms are used to model the entire power distribution network, the advantage is that the accuracy can be guaranteed, but the deficiency is that, it is difficult to provide time and machine resources required for solving the electromagnetic field with such a big bulk of data (hundreds of thousands of via and μbump connections) as per engineering need. It is thus desirable to have new technologies to solve electromagnetic fields quickly and precisely, and obtain the electromagnetic field model of the entire power distribution network.

For example, a Chinese patent filing no. CN2022100363508, with a publication date of May 27, 2022, discloses a chip packaging electromagnetic modeling system, method and device. A chip packaging electromagnetic modeling system, comprising a design module and a simulation module: the design module is configured to complete chip layout, build chip packaging and optimize and improve the chip packaging according to simulation results of chip packaging, and obtain a qualified chip packaging; the simulation module is configured to conduct simulation for the chip packaging in a design environment of the design module, and transmit the simulation results to the design module. The deficiency with the present technical solution is that: it is difficult to achieve both efficiency and accuracy.

For another example, a Chinese patent filing no. CN2017100006393 with a publication date of Jul. 10, 2018, discloses a method for building a 3D electromagnetic field parameterized simulation model, wherein by a complete method of extracting physical and geometrical parameters from physical layout, creating parameterized variants and 3D electromagnetic field parameterized simulation model, and improving design of the physical patterns after simulation and optimization, the modeling and simulation processes are simplified, modeling and simulation speed is improved and the time required for pattern design and simulation analysis is thus reduced. However, the defect with the technical solution is that, the accuracy is not guaranteed.

### SUMMARY OF THE INVENTION

### Technical Problems to be Solved

Targeting at the problem that for electromagnetic field modeling methods of large-scale power distribution networks currently available, it is not possible to promise both accuracy and speed, the present invention provides a chip packaging power distribution network electromagnetic modeling method and system. With the method proposed in the present invention, by decomposing and solving the power distribution network, time required for subsequent electromagnetic field modeling is substantially reduced, and by circuit connection of the decomposed and solved sub-magnetic field models, the large-scale electromagnetic field model in demand can be obtained and the accuracy is as desired. The system proposed in the present invention involves simple infrastructures, running of the modules is stable, while accuracy and speed of electromagnetic field modeling of large-scale power distribution network is promised simultaneously.

### Technical Solution

To address the foregoing problem, the present invention adopts the following technical solutions.

A chip packaging power distribution network electromagnetic modeling method, comprises:
S1: decomposing an initial power distribution network, and obtaining at least one decomposed region;
S2: conducting electromagnetic field solving for each of the at least one decomposed region, and obtaining at least one sub-magnetic field model;
S3: conducting circuit connection for each of the at least one sub-magnetic field model, and conducting circuit connection for neighboring sub-magnetic field models, and forming a complete circuit connection; and
S4: solving the complete circuit connection, and generating a complete electromagnetic field model.

### Further, the Step S1 Comprises:

S11: providing a plurality of decomposed planes on the initial power distribution network, wherein the plurality of decomposed planes separate the initial power distribution network uniformly into the at least one decomposed region; and
S12: providing a solving port at least one μbump and at least one bump of a power distribution network corresponding to each of the at least one decomposed region. Further still, the step S11 further comprises judging the plurality of decomposed planes, when the plurality of decomposed planes are located at positions of via, μbump, bump or flat, adjusting the plurality of decomposed planes to leave the positions of via, μbump, bump or flat.

### Further Still, the Step S2 Comprises the Following Steps:

S21: adding a power distribution network port and a ground network port for each of the at least one decomposed region, wherein the power distribution network port and the ground network port are provided at the decomposed plane of each of the at least one decomposed region; and
S22: conducting electromagnetic field solving for each of the at least one decomposed region with the method of moments (MOM) electromagnetic field simulation engine, and obtaining the at least one sub-magnetic field model.

### Still Further, the Step S3 Comprises the Following Steps:

S31: conducting circuit connection for each of the at least one sub-magnetic field model as per actual physical connections;
S32: using the power distribution network port and the ground network port at the decomposed plane of each of the at least one decomposed region as nodes of circuit connection and realizing circuit connection of neighboring sub-magnetic field models; and
S33: conducting circuit connection of neighboring sub-magnetic field models sequentially and forming the complete circuit connection.

Further still, obtaining the complete electromagnetic field model by circuit simulation of the complete circuit connection.

A system using the chip packaging power distribution network electromagnetic modeling method, comprises:
a decomposition module: configured to decompose an initial power distribution network into at least one decomposed region;
an electromagnetic field solving module: configured to conduct electromagnetic field solving for each of the at least one decomposed region and obtaining at least one sub-magnetic field model;
a circuit connection module: configured to conduct circuit connection for the at least one sub-magnetic field model and obtaining a complete circuit connection; and
an electromagnetic field model generation module: configured to solve the complete circuit connection and obtain a complete electromagnetic model.

### Beneficial Effects

Compared with the prior art, the beneficial effects of the present invention are that:
(1) By decomposing the large-scale initial power distribution network to be at least one decomposed region, computation resources are significantly saved, and time required for subsequent electromagnetic field modeling is reduced; further, by solving the at least one decomposed region, obtaining the at least one sub-magnetic field model, and obtaining the finally required electromagnetic model for the large-scale power distribution network by circuit connection of the at least one sub-magnetic field model, the accuracy of the final electromagnetic field model is promised to satisfy engineering need; compared with the conventional method of electromagnetic solving of the large-scale initial power distribution network directly the present method has a higher efficiency and accuracy;
(2) In the present invention, by separating the initial power distribution network to be at least one decomposed region evenly, it is convenient to calculate and the subsequent work can go on smoothly, in the meantime, by geometrical judgment of the decomposed planes, specific structures of the decomposed planes can be avoided, so that the decomposed planes are located at where interconnects are connected, connection of the decomposed planes will no longer cause any problem, and accuracy of the electromagnetic field model generated subsequently can be further promised; in the present invention, the MOM electromagnetic field simulation engine is used to conduct electromagnetic solving of each of the at least one decomposed region, with this method, it is no longer necessary to provide solving space, solving efficiency is improved; and by providing the power distribution network port and the ground network port at the decomposed plane to serve as nodes of subsequent circuit connection, the solving accuracy is further improved;
(3) With the system proposed in the present invention, by dividing the large-scale power distribution network to be small regions for solving with the decomposition module, the solving speed is significantly improved, the computation resources required are reduced, and parallel solving of the regions is possible, the solving speed is further enhanced, so is the working efficiency of the entire process; with the electromagnetic solving module, the decomposed regions are converted to be sub-magnetic field models, and by circuit interconnection of the sub-magnetic field models the final electromagnetic field model is obtained, compared with the conventional RLCK equivalent circuit solution, the accuracy at high frequencies is promised; the entire system is made of simple structures, running of each of the modules is stable, and simultaneously the large-scale power distribution network electromagnetic field modeling accuracy and speed is met.

### BRIEF DESCRIPTION OF DRAWINGS

FIG. 1 is a flowchart diagram showing the present invention;

FIG. 2 is a circuit cascading diagram showing a sub-magnetic field model of the present invention;

FIG. 3 is a self-impedance comparison diagram showing a power distribution network electromagnetic model with 20 μbump ports;

FIG. 4 is a diagram showing an impedance of the power distribution network electromagnetic field model after combing the 20 μbump ports; and

FIG. 5 is an impedance comparison diagram showing the power distribution network electromagnetic field after combing the 20 μbump ports.

### EMBODIMENTS

Hereinafter a further description will be given to the present invention in conjunction with the embodiments and the drawings.

### Embodiment 1

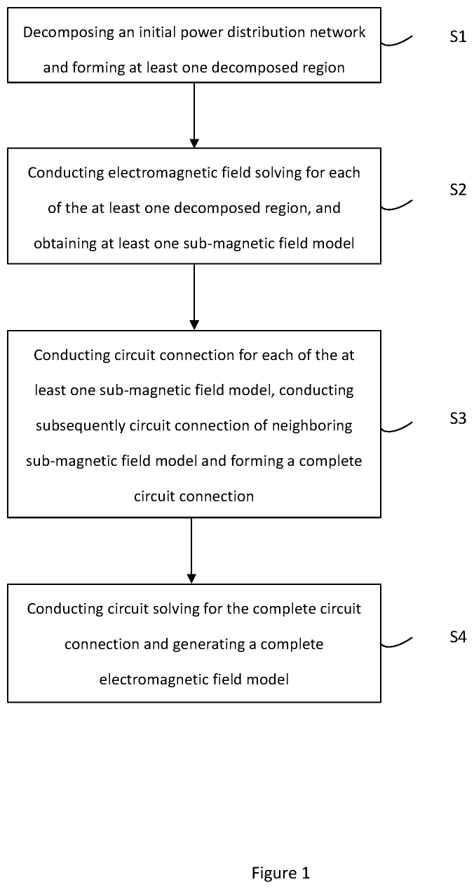

As shown in FIG. 1, a chip packaging power distribution network electromagnetic modeling method, comprises the following steps:
S1: decomposing an initial power distribution network as per a predetermined grid, and obtaining at least one decomposed region; and it is worth noting that, when to conduct decomposition treatment to the initial power distribution network, specifically, how many regions to decompose the initial power distribution network into can be determined according to the magnitude of visible data and resource allocation, and the standard for decomposition can be to separate into rectangles; specifically, step S1 comprises the following steps:
S11: a plurality of decomposed planes are provided on the initial power distribution network, the plurality of decomposed planes divide the initial power distribution network evenly into the at least one decomposed region; in the present embodiment, the initial power distribution network is divided evenly into six decomposed regions, and the purpose of dividing evenly is to facilitate calculation and summarize; further, in order to promise smooth completion of subsequent work, the present step further includes judging the decomposed planes, if the decomposed planes are located at where via (a via is a hole, located in the decomposed plane), μbump (micro bump), bump or flat of the initial power distribution network is located, moving the decomposed planes out of such structures, and the principle of providing the decomposed plane is to promise that the decomposed planes are located at where the routing is connected, to avoid influence of via or flat structures on subsequent connection, and on the entire accuracy; further, judging the decomposed planes by geometrical judgment, avoiding the parting planes to satisfy the decomposition of the structure, so that the decomposed planes are not located at the geometrical structures that may affect decomposition and solving, the judgment is more accurate and misjudgment can be reduced;
S12: providing solving ports for μbumps and bumps in the power distribution network corresponding to each of the decomposed region; In the step S1, the initial large-scale power distribution network is decomposed into at least one decomposed region, the solving speed is improved to a great deal and the computation resources are reduced; in the meanwhile, by parallel solving of each of the at least one decomposed region the purpose of expediting the solving is further achieved. In the present step, after dividing the large-scale power distribution network into 6 decomposed regions comparison of the consumed computation resource and the rate is shown in Table 1:

TABLE 1
comparison of resources consumed and efficiency of electromagnetic
field modeling by original large-scale network solving and
solving after decomposing into six decomposed regions

| | Memory consumption (GB) | Solving time (s) |
|---|---|---|
| Original large-scale | 182 | 2720 |
| network | | |
| Clip 1 | 28 | 305 |
| Clip 2 | 30 | 310 |
| Clip 3 | 26 | 264 |
| Clip 4 | 26 | 236 |
| Clip 5 | 26 | 245 |
| Clip 6 | 21 | 220 |

As can be seen in Table 1, after decomposing, compared with direct solving of the original large-scale network, for solving each of the decomposed regions, the memory resource consumption is reduced for 6-9 times, and the time consumption is reduced for 10 times. The total time of solving the six decomposed regions is 1580 s, even in case the six decomposed regions are calculated in series, the total time consumption is reduced from original 2720 s for 42%. Given that the decomposed regions can be calculated in parallel, the solving time can be reduced exponentially.

S2: conducting electromagnetic field solving for each of the decomposed regions, and obtaining a plurality of sub-magnetic field models; herein it is to be noted that, for conventional electromagnetic simulation of large-scale designs, the required computation resource is huge, the solving time is long, and conventionally, when dividing and cascading, usually the solving method of finite element method (FEM) is used, and with this kind of solving method, the boundary shall be set, with the integral design or the decomposed design, the boundaries are different, which may affect the results, and if the boundary for decomposed design is configured to be the same as the integral design in size, the simulation efficiency cannot be improved. And for the FEM, a reference shall be provided for the port, when providing a power distribution network port at the decomposed plane, the ground network port can only be set as the reference, however, at the decomposed plane, it is necessary to set the ground network port to be the port to conduct circuit connection for the decomposed electromagnetic field models, and if the ground network port is set to be the reference, finally, the accuracy deviation can be big; specifically, step 2 comprises the following steps:
S21: adding a power distribution network port and a ground network port for each of the decomposed region, the solving port in each of the decomposed region remains unchanged (for example, micro bump ports of a chip, C4 bump ports), both the power distribution network port and the ground network port is configured at the decomposed plane of each of the decomposed regions, which is different from the method that uses the ground network port as the reference, the port is directly provided for a cross section of the power distribution network at the decomposed plane of each of the decomposed regions, a port is provided at a cross section of the ground network, to connect with the ground network of the decomposed planes of other decomposed regions, the port is not used as the reference, and in this way, the entire accuracy can be improved;
S22: conducting electromagnetic field solving for each of the decomposed regions by MOM electromagnetic field simulation, obtaining a plurality of sub-magnetic field models, each of the sub-magnetic field model after solving comprises solving ports provided on the original micro bumps and bumps, and the power distribution network port and the ground network port; by using the MOM electromagnetic field simulation engine, solving space is not required, and the ground network which serves usually as a reference ground at the decomposed planes can be configured to be a normal port, and the accuracy can be promised.

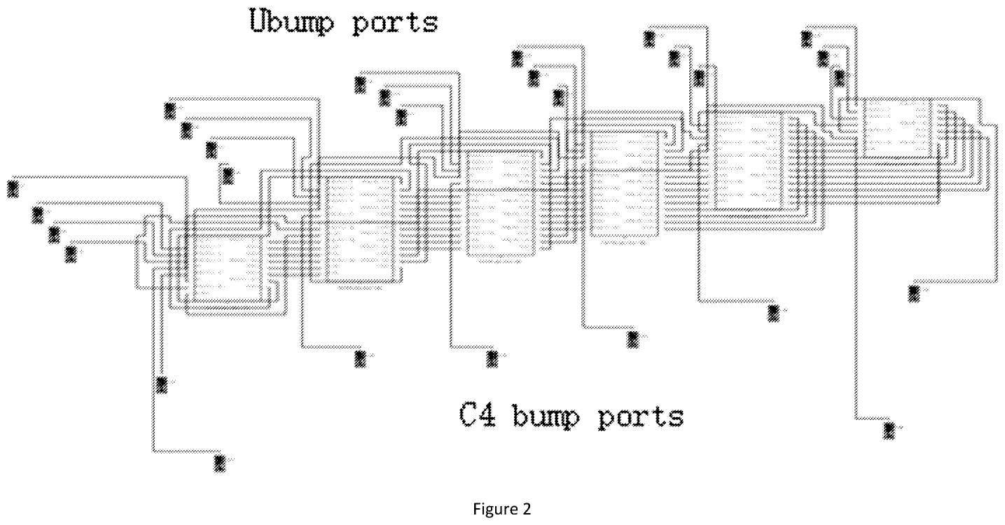

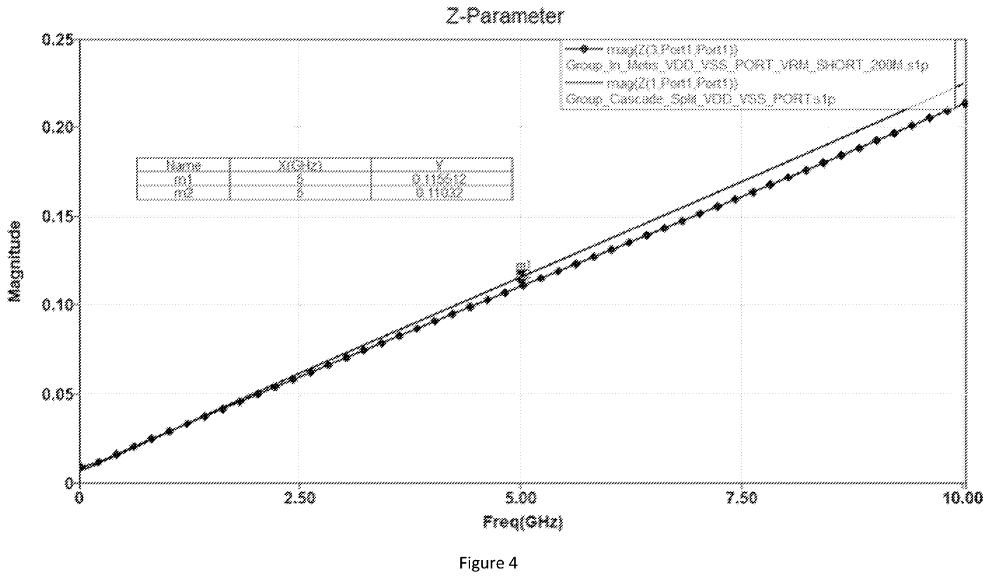

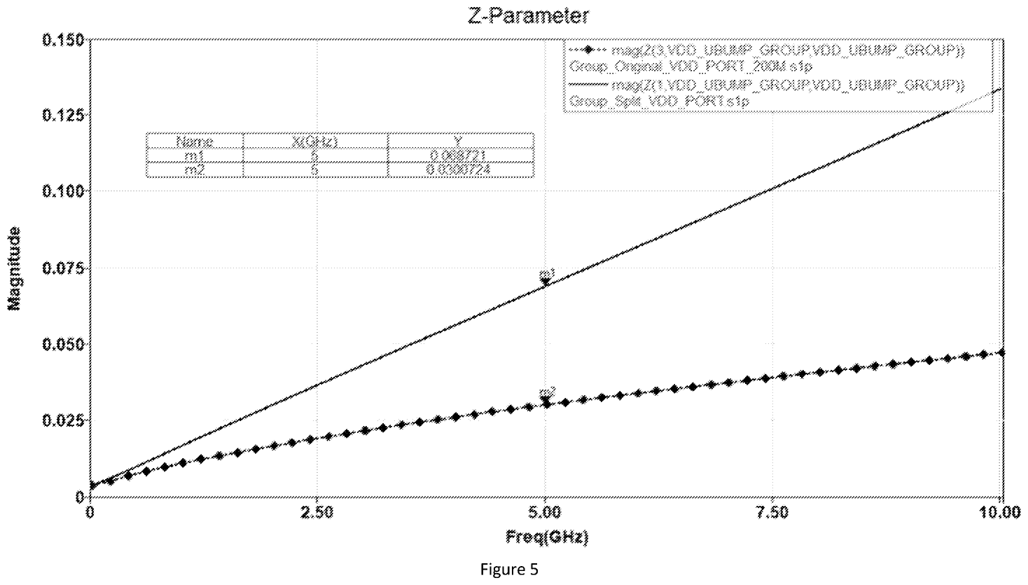

In the step S2, by solving with the MOM method, the limits of the conventional FEM method in decomposed region solving is efficiently avoided and it is no longer necessary to provide any boundary. More importantly, a power distribution network interface and a ground network interface are provided at the decomposed plane of each of the decomposed regions, and the ground network interface is not used as the reference. If the ground network is set to be the reference at the decomposed plane, when to cascade the circuit, that is, to conduct subsequent circuit connection, only the power distribution network is connected, the ground network serves directly as the reference, in this case, when combing the 20 micro bump ports to see the impedance of the entire chip packaging power distribution network design, it can be seen that, at 5 GHZ, the impedance of the entire network solving model is 0.03007, the impedance solved by region decomposition circuit cascading is 0.068721, the deviation is not acceptable, as shown in FIG. 5, in FIG. 5, the green lines are used to represent direct electromagnetic solving of the entire initial power distribution network; the red lines are used to represent the method of decomposing the initial power distribution network and conducting circuit cascading, however, at the decomposed planes there are only the power distribution network interfaces. However, with the method provided in the present invention, by combining 20 micro bumps together to see the impedance of the entire chip packaging power distribution network design, it can be known that, at 5 GHZ, the impedance of the entire network solving model is 0.11032, and the impedance solved by region decomposition and circuit cascading is 0.115512, the deviation is 4.71%, which is acceptable, as shown in FIG. 4, in FIG. 4, the green lines are used to represent direct electromagnetic solving of the entire initial power distribution network; the red lines are used to represent the method of decomposing the initial power distribution network into clips and conducting circuit cascading, however, at the decomposed planes, there are the power distribution network interfaces and the ground network interfaces.
S3: conducting circuit connection for each of the sub-magnetic field models, and subsequently, conducting circuit connection of neighboring sub-magnetic field models, to form a complete circuit connection; in the present step, for each of the sub-magnetic field model, by conducting circuit connection according to actual physical connections, the power distribution network interfaces and the ground network interfaces provided in the step S2 are used as nodes of the circuit connection to realize circuit connection of the neighboring sub-magnetic field models, wherein, the solving ports on the original micro bumps and the bumps still serve as the interfaces and remain unchanged. Specifically, the step S3 comprises the following steps:
S31: conducting circuit connection for each of the sub-magnetic field models as per actual physical connections;
S32: using the power distribution network interfaces and the ground network interfaces provided at the decomposed plane of each of the decomposed regions as nodes of the circuit connection to realize circuit connection of neighboring sub-magnetic field models, as shown in FIG. 2;
S33: conducting circuit connection of neighboring sub-magnetic field models in sequence and forming the final circuit connection.
S4: conducting circuit solving for the complete circuit connection, and generating a complete electromagnetic field model. In the present step, the complete electromagnetic field model is obtain by circuit simulation solving of the complete circuit, and circuit simulation solving is quick while of high precision.

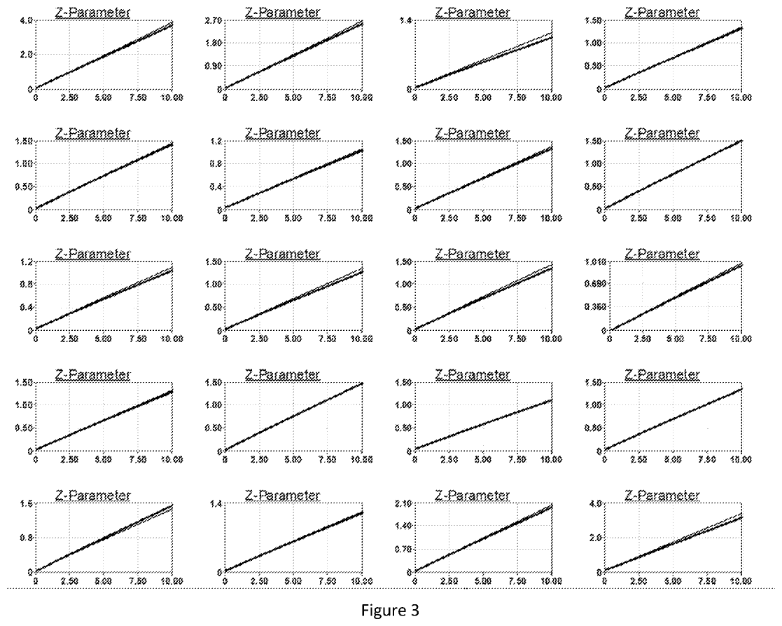

In the present invention, by decomposing the large-scale initial power distribution network, conducting electromagnetic solving for each of the decomposed regions, the accuracy at high frequencies of equivalent RLCK circuits and the efficiency and consumption of electromagnetic field solving of the entire large-scale network is avoided; further, by providing the power distribution network interface and the ground network interface as nodes of subsequent circuit connection, the sub-magnetic field model of each of the decomposed regions is combined to be a final large-scale electromagnetic field model accurately, which is sufficient to meet engineering need. In the meanwhile, the present invention has done the following test: in the present invention, the electromagnetic field model obtained with the method offered in the present invention is compared with the electromagnetic field model obtained by direct solving of the initial power distribution network. As the electromagnetic field model concentrates on impedance, during comparison, the C4 bump port is short-circuited to check the self-impedance at the 20 micro bump ports, the accuracy result is shown in FIG. 3, and in FIG. 3, the green lines are used to represent direct solving of the initial power distribution network; the red lines are used to represent the technical solution in the present invention, that is, decomposing the initial power distribution network and circuit cascading for solving. Impedance comparison of the three curves with the biggest deviations at 5 GHz is shown in Table 2, wherein for the case with the smallest deviation, at 5 GHZ, the deviation is close to 0.

TABLE 2
impedance comparison of direct solving of the initial
power distribution network and solving by decomposing
and circuit cascading at 5 GHz network direction

| | Initial network direction | Decomposing and circuit | Deviation |
|---|---|---|---|
| Port no. | solving impedance | cascading impedance | (%) |
| Z3 | 0.542518 | 0.589599 | 8.68% |
| Z10 | 0.651883 | 0.688386 | 5.60% |
| Z20 | 1.63037 | 1.7374 | 6.56% |

As can be seen in Table 2, for the electromagnetic field model obtained in the present invention, even at the high frequency of 5 GHZ (usually the frequency range of power distribution network models is concentrated in 1-2 GHZ), the deviation is less than 10%, which meets the engineering need, which computation resources are remarkably saved. Therefore, compared with large-scale direct electromagnetic field solving of the initial power distribution network, the present invention has the higher efficiency and accuracy.

### Embodiment 2

A system employing the chip packaging power distribution network electromagnetic modeling method, comprises:

A decomposition module: configured to decompose the initial power distribution network to be a plurality of decomposed regions; a standard of the decomposition module can be determined as per the magnitude of data and resource configurations, further, algorithms on decomposition of the initial power distribution network is relatively mature, therefore, in the present embodiment, the principle with regard to how to decompose with the decomposition module will not be elaborated on. The standard of decomposition shall promise that the decomposed planes are located where the routings are connected, so as to avoid via or flat structures in the decomposed planes and affect the subsequent connection, and the entire precision. An electromagnetic field solving module: configured to conduct electromagnetic field solving for each of the decomposed regions, and obtain sub-magnetic field models; the electromagnetic field solving module uses the MOM electromagnetic field simulation engine for solution, whereby avoiding restrictions of the conventional FEM method on decomposition and solution; further, the present electromagnetic field solving module will provide automatically a power distribution network interface and a ground network interface at the decomposed plane of each of the decomposed regions, and the power distribution network interface and the ground network interface serve as the nodes of subsequent circuit connection to promise accuracy and reduce deviation.

A circuit connection module: configured to conduct circuit connection for the sub-magnetic field models, and obtain the complete circuit connection; and for the circuit connection module, first of all, conducting circuit connection of the sub-magnetic fields based on actual physical connections, and connecting the neighboring sub-magnetic field models via the power distribution network interfaces and the ground network interfaces to obtain the complete circuit connection.

An electromagnetic model generation module: configured to solve the complete circuit connection by circuit simulation and obtain the complete electromagnetic field model.

With the system provided in the present invention, the large-scale power distribution network is divided into small regions for solving, the solving speed is expedited significantly, the computation resource required is reduced, furthermore, solving of the regions can be done in parallel, the solving speed is further improved, so is the working efficiency of the entire process; by converting the decomposed regions to be sub-magnetic field models with the electromagnetic field solving module, and obtaining the final electromagnetic model by circuit interconnection, compared with the conventional RLCK equivalent circuit solution, the accuracy at high frequencies can be met; the structures of the entire system are simple, running of the modules is stable, accuracy and speed of the electromagnetic field modeling of large-scale power distribution networks can be simultaneously satisfied.

The embodiments given in the present invention are only some preferable embodiments, and are not intended to limit the idea and spirit of the present invention, without departing from the idea of the present invention, all modifications and improvements made by those skilled in the art to the technical solutions of the present invention shall fall into the protection scope of the present invention.

1. A chip packaging power distribution network electromagnetic modeling method, comprises:
S1: decomposing an initial power distribution network, and obtaining at least one decomposed region;
S2: conducting electromagnetic field solving for each of the at least one decomposed region, and obtaining at least one sub-magnetic field model;
S3: conducting circuit connection for each of the at least one sub-magnetic field model, and conducting circuit connection for neighboring sub-magnetic field models, and forming a complete circuit connection; and
S4: solving the complete circuit connection, and generating a complete electromagnetic field model.

2. The chip packaging power distribution network electromagnetic modeling method according to claim 1, wherein the step S1 comprises:
S11: providing a plurality of decomposed planes on the initial power distribution network, wherein the plurality of decomposed planes separate the initial power distribution network uniformly into the at least one decomposed region; and
S12: providing a solving port at at least one μbump and at least one bump of a power distribution network corresponding to each of the at least one decomposed region.

3. The chip packaging power distribution network electromagnetic modeling method according to claim 2, wherein the step S11 further comprises judging the plurality of decomposed planes, when the plurality of decomposed planes are located at positions of via, μbump, bump or flat, adjusting the plurality of decomposed planes to leave the positions of via, μbump, bump or flat.

4. The chip packaging power distribution network electromagnetic modeling method according to claim 1, wherein the step S2 comprises the following steps:
S21: adding a power distribution network port and a ground network port for each of the at least one decomposed region, wherein the power distribution network port and the ground network port are provided at the decomposed plane of each of the at least one decomposed region; and
S22: conducting electromagnetic field solving for each of the at least one decomposed region with a method of moments (MOM) electromagnetic field simulation engine, and obtaining the at least one sub-magnetic field model.

5. The chip packaging power distribution network electromagnetic modeling method according to claim 4, wherein the step S3 comprises the following steps:
S31: conducting circuit connection for each of the at least one sub-magnetic field model as per actual physical connections;
S32: using the power distribution network port and the ground network port at the decomposed plane of each of the at least one decomposed region as nodes of circuit connection and realizing circuit connection of neighboring sub-magnetic field models; and
S33: conducting circuit connection of neighboring sub-magnetic field models sequentially and forming the complete circuit connection.

6. The chip packaging power distribution network electromagnetic modeling method according to claim 1, wherein obtaining the complete electromagnetic field model by circuit simulation of the complete circuit connection.

7. A system using the chip packaging power distribution network electromagnetic modeling method as defined in claim 1, comprises:
a decomposition module: configured to decompose an initial power distribution network into at least one decomposed region;
an electromagnetic field solving module: configured to conduct electromagnetic field solving for each of the at least one decomposed region and obtaining at least one sub-magnetic field model;
a circuit connection module: configured to conduct circuit connection for the at least one sub-magnetic field model and obtaining a complete circuit connection; and
an electromagnetic field model generation module: configured to solve the complete circuit connection and obtain a complete electromagnetic model.
